(19) United States
(12) Patent Application Publication
(10) Pub. No.: US 2025/0171288 A1
(43) Pub. Date: May 29, 2025

(54) MATHEMATICAL CALCULATOR AND METHOD OF USING THE SAME

(71) Applicant: KFIR OHAYON, NAHARIYA (IL)

(72) Inventor: KFIR OHAYON, NAHARIYA (IL)

(21) Appl. No.: 19/034,410

(22) Filed: Jan. 22, 2025

Related U.S. Application Data
(63) Continuation of application No. 17/187,754, filed on Feb. 27, 2021, now abandoned.

(51) Int. Cl. B66F 11/00; B25J 9/10; B66F 7/14

(52) U.S. Cl. CPC B66F 11/00; B66F 7/14; B25J 9/104; B66F 2700/04

(57) ABSTRACT

A mathematical calculator, and a method of using the same, is disclosed which can help people, particularly children, to easily learn and master multiplication operations. The mathematical calculator comprises a substantially cylindrical platform, and in accordance with a first embodiment, the multiplicands and multipliers are located within a plurality of columns and rows defined upon a plurality of adjacent wheels which are rotatable around a longitudinal axis of the platform, whereas in accordance with a second embodiment, the multiplicands and multipliers are located within a plurality of columns and rows which are defined upon a solid block.

### CROSS-REFERENCE TO RELATED PATENT APPLICATIONS

This patent application is a Continuation of U.S. patent application Ser. No. 17/187,754 filed on Feb. 27, 2021.

### TITLE OF THE INVENTION

MATHEMATICAL CALCULATOR AND METHOD OF USING THE SAME

### FIELD OF THE INVENTION

The present invention relates to a mathematical calculator, and more particularly to a mathematical calculator, and a method of using the same, which can help people, particularly children, to easily learn and master multiplication operations.

### BACKGROUND OF THE INVENTION

Multiplication is one of the most fundamental mathematical operations that one needs to learn, particularly at a young age, in order to successfully navigate one's personal life, and/or career, such as, for example, physics, engineering, or any other career requiring a basic understanding of mathematical operations inherently involving numbers, quantities, space, and the like, however, it seems that learning basic multiplication is also one of the most difficult operations or concepts to master.

Accordingly, a need exists in the art exists for a new and improved multiplication calculator. Another need exists in the art for a new and improved multiplication calculator that can help people, particularly young children, to easily learn basic multiplication operations. Still another need exists in the art for a new and improved multiplication calculator that can help people, particularly young children, to easily learn and master basic multiplication operations. Yet another need exists in the art for a new and improved multiplication calculator that is easy to use and can therefore help people, particularly young children, to easily learn and master basic multiplication operations. Still yet another need exists in the art for a new and improved multiplication calculator that is easy and fun or interesting to use and can therefore help people, particularly young children, to easily learn and master basic multiplication operations.

### OVERALL OBJECTIVES OF THE PRESENT INVENTION

Accordingly, an overall objective of the present invention is to provide a new and improved multiplication calculator. Another overall objective of the present invention is to provide a new and improved multiplication calculator that can help people, particularly young children, to easily learn basic multiplication operations. Still another overall objective of the present invention is to provide a new and improved multiplication calculator that can help people, particularly young children, to easily learn and master basic multiplication operations. Yet another overall objective of the present invention is to provide a new and improved multiplication calculator that is easy to use and can therefore help people, particularly young children, to easily learn and master basic multiplication operations. Still yet another overall objective of the present invention is to provide a new and improved multiplication calculator that is easy and fun or interesting to use and can therefore help people, particularly young children, to easily learn and master basic multiplication operations.

### SUMMARY OF THE INVENTION

The present invention is directed toward a multiplication calculator wherein, in accordance with a first embodiment of the present invention, there is provided a multiplication calculator which comprises a substantially cylindrical platform having a plurality of rotatable wheels which are mounted upon an axle such that the plurality of rotatable wheels are rotatable around a longitudinal axis defined by the axle such that the plurality of rotatable wheels are capable of being moved or rotated in a stepwise manner, and wherein all of the wheels are located within adjacent planes with respect to each other. All of the wheels have a plurality of steps or facets, such as, for example, ten steps or facets, defined thereon, and the first wheel has multiplicands noted upon each step or facet ranging from zero (0) to nine (9). In addition, there are an additional nine (9) wheels, which effectively contain the multipliers or answers noted upon their steps or facets. More particularly, these additional wheels contain numbers which extend from zero (0) to eighteen (18) in increments of two upon the second wheel, numbers which extend from zero (0) to twenty-seven (27) in increments of three upon the third wheel, numbers which extend from zero (0) to thirty-six (36) in increments of four upon the fourth wheel, numbers which extend from zero (0) to forty-five (45) in increments of five upon the fifth wheel, numbers which extend from zero (0) to fifty-four (54) in increments of six upon the sixth wheel, numbers which extend from zero (0) to sixty-three (63) in increments of seven upon the seventh wheel, numbers which extend from zero (0) to seventy-two (72) in increments of eight upon the eighth wheel, numbers which extend from zero (0) to eighty-one (81) in increments of nine upon the ninth wheel, and numbers which extend from zero (0) to ninety (90) in increments of ten upon the tenth wheel.

A plurality of windows are provided within a linear array extending across the calculator such that when you rotate a particular one of the multiplier wheels in accordance with a particular number of steps or partial rotations, and in accordance with a particularly selected multiplier, the answer will appear within that particular window operatively associated with the particular wheel that was rotated. In use, let us take as an example, the multiplication problem of 3×7.Therefore, one would locate the three (3) upon the first wheel, since three (3) is the multiplicand, then move horizontally across the array of wheels, within the row of the number three (3) multiplicand, until one comes to the seventh wheel, then rotate the seventh wheel three steps, corresponding to the multiplicand, and the answer of twenty-one (21) will appear within the window, operatively associated with the seventh wheel, disclosing the answer to the multiplication problem.

In accordance with a second embodiment of the present invention, the structure of the second embodiment is somewhat similar to that of the first embodiment except that in lieu of rotatable wheels, all of the multiplicands and answers are noted upon the plurality of steps or facets defined upon a solid block wherein, in a manner similar to that of the first embodiment, the numbers are arranged in adjacent columns which extend around the external periphery of the solid block, as well as in adjacent rows which extend across the solid block. In use, and using the same example of multiplying 3×7, one would again locate the three (3) within the first column, and then move laterally across the solid block, within the row of the multiplicand three (3), to the seventh column where the numerical answer of twenty-one (21) will be located.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a schematic view of a first embodiment of a new and improved multiplication calculator as constructed in accordance with the teachings and principles of the present invention; and

FIG. 2 is a schematic view of a second embodiment of a new and improved multiplication calculator as constructed in accordance with the principles and teachings of the present invention.

### DETAILED DESCRIPTION OF THE PREFERRED EMBODIMENT

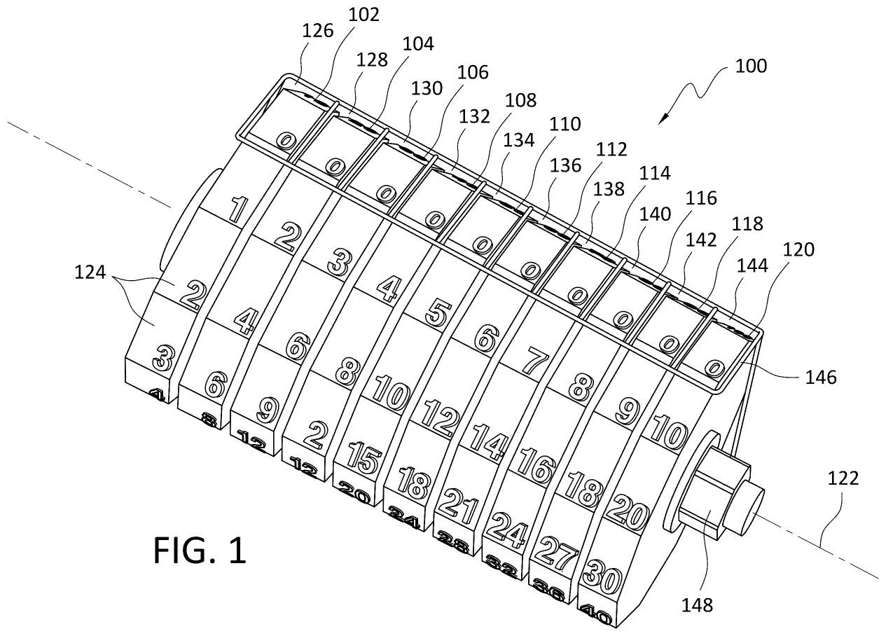

Referring now to the drawings, and more particularly to FIG. 1 thereof, a first embodiment of a new and improved multiplication calculator is disclosed and is generally indicated by the reference character 100. More particularly, it is seen that in accordance with the principles and teachings of the present invention, the multiplication calculator 100 comprises a substantially cylindrical device or platform comprising a plurality of independently rotatable wheels 102,104,106, 108,110, 112,114, 116, 118, 120 which are mounted upon an axle defining an axis 122 around which the plurality of rotatable wheels 102-120 are capable of being moved or rotated in a stepwise manner, and wherein all of the wheels are located within adjacent planes with respect to each other. Continuing further, it is additionally seen that all of the wheels have a plurality of steps or facets 124 defined around the external peripheral surface of the platform, such as, for example, ten steps or facets, upon which various numbers or numerical values are noted, and it is seen that the first wheel 102 has numbers disposed thereon which will serve as the multiplicands to be multiplied by a particular multiplier. Even more particularly, it is noted that the ten steps or facets disposed upon the first wheel have numbers noted thereon ranging from zero (0) to nine (9) in increments of one (1). In addition, the additional nine (9) wheels 104-120 effectively contain the multipliers or answers. More particularly, it is seen that these additional wheels 104-120 contain numbers which extend from zero (0) to eighteen (18) in increments of two upon the second wheel 104, numbers which extend from zero (0) to twenty-seven (27) in increments of three upon the third wheel 106, numbers which extend from zero (0) to thirty-six (36) in increments of four upon the fourth wheel 108, numbers which extend from zero (0) to forty-five (45) in increments of five upon the fifth wheel 110, numbers which extend from zero (0) to fifty-four (54) in increments of six upon the sixth wheel 112, numbers which extend from zero (0) to sixty-three (63) in increments of seven upon the seventh wheel 114, numbers which extend from zero (0) to seventy-two (72) in increments of eight upon the eighth wheel 116, numbers which extend from zero (0) to eighty-one (81) in increments of nine upon the ninth wheel 118, and numbers which extend from zero (0) to ninety (90) in increments of ten upon the tenth wheel 120. More particularly, each wheel 102-120 effectively comprises a column of numbers arranged around the outer periphery of the device, while successive facets, disposed upon the adjacent wheels, effectively comprise rows of numbers extending across the device.

In addition, a plurality of windows 126-144 are provided within a linear array that extends across the calculator 100 such that each window 126-144 is respectively associated with one of the rotatable wheels 102-120. The linear array of windows 126-144 may all be mounted upon a framework 146 which, in turn, may be fixedly secured to a non-rotatable portion of a housing structure 148 through which the axle 122 extends. Accordingly, when a particular one of the wheels 104-120 is rotated in accordance with a particular number of steps or partial rotations, in accordance with a particular multiplier being used to multiply a particular one of the multiplicands noted upon the first wheel 102, the answer will appear within the particular window operatively associated with the particular one of the wheels 104-120 that was rotated.

### Exemplary Use of the First Embodiment

In order to clearly demonstrate the use of the first embodiment of the mathematical calculator 100 of the present invention, let us take as an example, the multiplication problem of 3×7. Therefore, using the mathematical calculator 100, one would locate the three (3) upon the first wheel 102, since three (3) is the multiplicand, then move horizontally across the array of wheels 104-120, while remaining within the same row as the multiplicand three (3) is located, until one comes to the seventh wheel 114, then rotate the seventh wheel 114 three steps, corresponding to the multiplicand, whereby such rotation will bring the particular facet 124, upon which the number twenty-one (21) appears, into the window 138, thereby clearly presenting the answer of twenty-one (21) to the multiplication problem. As previously noted, the use and manipulation of the mathematical calculator in accordance with the foregoing principles and teachings, will help people, particularly, young children, to learn their multiplication tables or to help such children confidently master multiplication problems.

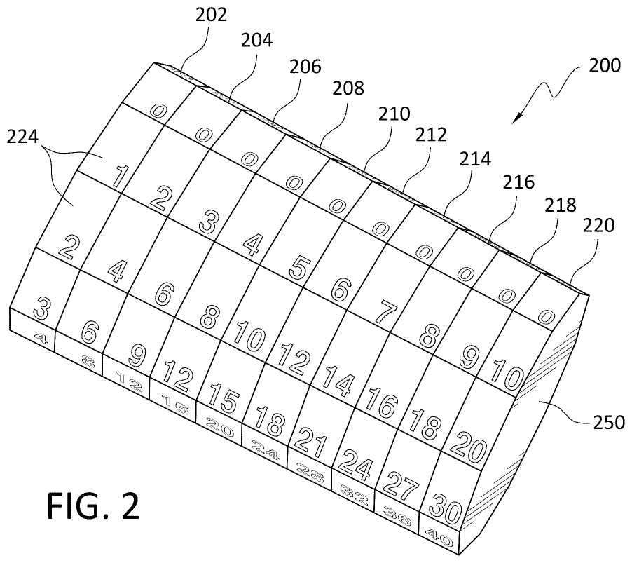

Continuing further, a second embodiment of the present invention is disclosed within FIG. 2 and is generally indicated by the reference character 200. It is to be noted that the second embodiment of the mathematical calculator comprises structural features which are similar or correspond to those of the first embodiment of the mathematical calculator 100 and will therefore be indicated by corresponding reference characters except that they will be within the 200 series. More particularly, it is seen that the structure of the second embodiment mathematical calculator 200 is somewhat similar to that of the first embodiment mathematical calculator 100 except for the fact that in lieu of the plurality of rotatable wheels 102-120, all of the multiplicands and answers are noted upon the plurality of facets 224 of a solid block 250 which may be fabricated from any suitable material, such as, for example, wood, plastic, metal, or the like, and wherein, in a manner similar to that of the first embodiment of the mathematical calculator 100, the numbers are arranged in adjacent columns 202-220 which extend around the external periphery of the solid block 250 and with similar increments therebetween, as well as across the solid block 250 in rows, wherein serially arranged facets of a particular row contain numbers which comprise successive increments of the multiplicand located within the first column 202.

### Exemplary Use of the Second Embodiment

Therefore, in a manner similar to that of the first embodiment of the mathematical calculator 100 of the present invention, in order to clearly demonstrate the use of the second embodiment of the mathematical calculator 200 of the present invention, let us take the same example that we used in conjunction with the first embodiment of the mathematical calculator 100 of the present invention, that is, the multiplication problem of 3×7. Therefore, using the mathematical calculator 200, one would locate the three (3) within the first column 202, since three (3) is the multiplicand, then move horizontally across the array of facets 224, while remaining within the row containing the multiplicand three (3), until one comes to the seventh column 214, whereby the answer of twenty-one (21) to the multiplication problem is clearly presented. As previously noted, the use and manipulation of the mathematical calculator in accordance with the foregoing principles and teachings, will help people, particularly, young children, to learn their multiplication tables or to help such children confidently master multiplication problems.

Obviously, many variations and modifications of the present invention are possible in light of the above teachings. It is therefore to be understood that within the scope of the appended claims, the present invention may be practiced otherwise than as specifically described herein.

What is claimed and sought to be protected by Letters Patent, is:

1. A mathematical calculator, comprising:
a substantially cylindrical platform having an external peripheral surface defined around a longitudinal axis and comprising an array of a plurality of axially spaced wheels which are independently rotatable around said longitudinal axis;
a plurality of adjacent columns defined upon said plurality of wheels comprising said substantially cylindrical platform, extending around said external peripheral surfaces of each one of said plurality of wheels, and having a plurality of integer numbers defined thereon which comprise serial numbers corresponding to which number a particular wheel is within said array of said plurality of axially spaced wheels;
a plurality of rows extending across said plurality of wheels and comprising said substantially cylindrical platform so as to extend substantially parallel to said longitudinal axis, and having a plurality of integer numbers defined thereon which comprise serial numbers which are multiples of said multiplicand disposed within said first column upon said first wheel;
wherein a first column of said plurality of adjacent columns, defined upon a first one of said plurality of wheels, contains a plurality of integer numbers which serve as multiplicands, while said plurality of rows, defined upon remaining ones of said plurality of wheels, contain a plurality of integer numbers which serve as serial multiplication products of said multiplicand, disposed within said first column defined upon said first one of said plurality of wheels, when said multiplicand is multiplied by a particular multiplier;
wherein said plurality of multiplicands and said plurality of serial multiplication products are defined upon a plurality of steps or facets comprising each one of said plurality of columns and rows defined upon said plurality of wheels; and
a plurality of windows, respectively associated with each one of said plurality of columns, mounted upon said substantially cylindrical platform so as to enable one to view the answer to a multiplication problem when one of said plurality of wheels is rotated a predetermined number of times, corresponding to a predetermined number of steps or facets, and corresponding to a particular multiplicand, such that the answer to said multiplication problem will be displayed within said window;
whereby when it is desired to multiply a particular multiplicand by a particular multiplier, the correct answer to a multiplication problem, whereby the multiplicand is multiplied by a particular multiplier, will be displayed within one of said plurality of windows as a result of one of said plurality of wheels, corresponding to the multiplier, being rotated a predetermined number of times, corresponding to said predetermined number of steps or facets, and corresponding to said multiplicand.

2. The calculator as set forth in claim 1, wherein:
when it is desired to solve a multiplication problem, a particular multiplicand, located upon said first one of said plurality of wheels, is selected, one moves across said plurality of rows until one reaches a wheel corresponding to a particular multiplier, whereupon rotation of said multiplier wheel a number of steps corresponding to said multiplicand, the answer to said multiplication problem will appear with said window, of said plurality of windows, corresponding to the multiplier wheel.

3. A method of using a mathematical calculator for solving multiplication problems, comprising:
providing a substantially cylindrical platform having an external peripheral surface defined around a longitudinal axis and comprising an array of a plurality of axially spaced wheels which are independently rotatable around said longitudinal axis;
defining a plurality of adjacent columns, upon said plurality of wheels comprising said substantially cylindrical platform such that said plurality of adjacent columns extend around said external peripheral surface of said platform, wherein each one of said columns comprises a plurality of integer numbers defined thereon which comprise serial numbers that correspond to which number wheel a particular wheel is within said array of axially spaced wheels;
providing a plurality of rows extending across said plurality of wheels and comprising said substantially cylindrical platform so as to extend substantially parallel to said longitudinal axis, and having a plurality of integer numbers defined thereon;
wherein a first column of said plurality of adjacent columns, defined upon a first one of said plurality of wheels, contains a plurality of integer numbers which serve as multiplicands, while said plurality of rows, defined upon remaining ones of said plurality of wheels, contain a plurality of integer numbers which serve as serial multiplication products of said multiplicands defined within said first column upon said first one of said plurality of wheels;
wherein said plurality of multiplicands and said plurality of serial multiplication products are defined upon a plurality of steps or facets comprising each one of said plurality of columns and rows defined upon said plurality of wheels;
providing a plurality of windows, respectively associated with each one of said plurality of columns, upon said substantially cylindrical platform so as to enable one to view the answer to a multiplication problem when one of said plurality of wheels is rotated a predetermined number of times, corresponding to a predetermined number of steps or facets, and corresponding to a particular multiplicand, such that the answer to said multiplication problem will be displayed within said window;
selecting a multiplicand from said first column of said plurality of integer numbers;
moving across said row corresponding to said selected multiplicand, a predetermined number of columns and in accordance with a predetermined multiplier so that you are now on a product wheel; and
rotating said product wheel a number of steps/facets corresponding to said selected multiplicand,
whereby the correct answer to a multiplication problem, whereby the multiplicand is multiplied by a particular multiplier, will be displayed within one of said plurality of windows disposed above said product wheel.
